(19) United States
(12) Patent Application Publication
(10) Pub. No.: US 2026/0065465 A1
(43) Pub. Date: Mar. 5, 2026

(54) IMAGE INSPECTION APPARATUS, IMAGE INSPECTION METHOD, AND NON-TRANSITORY RECORDING MEDIUM

(71) Applicant: Kazuhiro IJICHI, Kanagawa (JP)

(72) Inventor: Kazuhiro IJICHI, Kanagawa (JP)

(21) Appl. No.: 19/309,690

(22) Filed: Aug. 26, 2025

(30) Foreign Application Priority Data
Sep. 2, 2024 (JP) 2024-150542

(51) Int. Cl. G06T 7/00; G06F 3/12; H04N 1/00

(52) U.S. Cl. CPC G06T 7/001; G06F 3/1208; G06F 3/1259; H04N 1/00795; G06T 2207/30144

(57) ABSTRACT

An image inspection apparatus includes circuitry. The circuitry inputs a master image, the master image being original data for printing. The circuitry inputs a scanned image acquired by reading, with a reading device, an image printed by an image forming apparatus performing a print job. The circuitry compares the master image and the scanned image to detect a defective portion in the scanned image. The circuitry digitizes a feature amount of the defective portion to assign a level to the defective portion based on the feature amount. The circuitry sorts detected defect pages of the print job each page having the defective portion assigned with the level by the level of the defective portion in the detected defect page. The circuitry displays a list of the detected defect pages in an order having been sorted.

### CROSS-REFERENCE TO RELATED APPLICATION

This patent application is based on and claims priority pursuant to 35 U.S. C. § 119(a) to Japanese Patent Application No. 2024-150542, filed on Sep. 2, 2024, in the Japan Patent Office, the entire disclosure of which is hereby incorporated by reference herein.

### BACKGROUND

### Technical Field

The present disclosure relates to an image inspection apparatus, an image inspection method, and a non-transitory recording medium.

### Related Art

In an image defect inspection apparatus, generally, a level of a defect to be detected is designated.

Since a user usually sets the level of the defect to be detected rather strictly to prevent the defect from being overlooked, the image of defect detected by the image defect inspection apparatus tends to include a defect of a level that does not cause a problem for the user. In this case, the user needs to visually inspect the presence or absence of the problem and sort the defects.

For example, to easily change the level of inspection, a configuration is proposed in which a first defect is inspected at a first level of inspection, a second defect is automatically inspected at a second level of inspection, and the first defect and the second defect are displayed in a distinguishable manner. A mechanism for displaying the results of detecting defects at a plurality of detection levels has been proposed, but this does not reduce the above-described user's time and effort.

### SUMMARY

The present disclosure described herein provides an image inspection apparatus. The image inspection apparatus includes circuitry. The circuitry inputs a master image, the master image being original data for printing. The circuitry inputs a scanned image acquired by reading, with a reading device, an image printed by an image forming apparatus performing a print job. The circuitry compares the master image and the scanned image to detect a defective portion in the scanned image. The circuitry digitizes a feature amount of the defective portion to assign a level to the defective portion based on the feature amount. The circuitry sorts detected defect pages of the print job each page having the defective portion assigned with the level by the level of the defective portion in the detected defect page. The circuitry displays a list of the detected defect pages in an order having been sorted.

The present disclosure described herein provides an image inspection method performed by an image inspection apparatus. The image inspection method includes inputting a master image, the master image being original data for printing. The image inspection method includes inputting a scanned image acquired by reading an image with a reading device, the image printed by an image forming apparatus performing a print job. The image inspection method includes comparing the master image and the scanned image to detect a defective portion in the scanned image. The image inspection method includes digitizing a feature amount of the defective portion to assign a level to the defective portion based on the feature amount. The image inspection method includes sorting detected defect pages of the print job each having the defective portion assigned with the level by the level of the defective portion in the detected defect page. The image inspection method includes displaying a list of the detected defect pages in an order sorted by the sorting.

The present disclosure described herein provides a non-transitory recording medium storing a plurality of instructions which, when executed by one or more processors, causes the one or more processors to perform an image inspection method. The image inspection method includes inputting a master image, the master image being original data for printing. The image inspection method includes inputting a scanned image acquired by reading an image with a reading device, the image printed by an image forming apparatus performing a print job. The image inspection method includes comparing the master image and the scanned image to detect a defective portion in the scanned image. The image inspection method includes digitizing a feature amount of the defective portion to assign a level to the defective portion based on the feature amount. The image inspection method includes sorting detected defect pages of the print job each having the defective portion assigned with the level by the level of the defective portion in the detected defect page. The image inspection method includes displaying a list of the detected defect pages in an order sorted by the sorting.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a functional configuration of an image defect inspection apparatus;

FIG. 2 is a flowchart of a process of displaying a list of detected defect pages in an image defect inspection apparatus;

FIG. 3 is a diagram illustrating a list of results of detected defect in a print job in an image defect inspection apparatus;

FIG. 4 is a diagram illustrating a list of results of detected defect in a print job in an image defect inspection apparatus;

FIG. 5 is a diagram illustrating a list of results of detected defect in a print job in an image defect inspection apparatus; and

FIG. 6 is a diagram illustrating a list of results of detected defect in a print job in an image defect inspection apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of an image defect inspection apparatus to which an image inspection apparatus, an image inspection method, and a non-transitory recording medium are applied is described in detail below, with reference to the accompanying drawings.

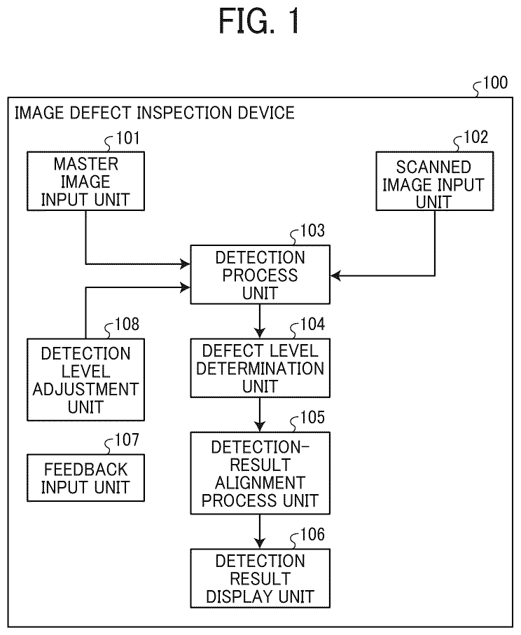

FIG. 1 is a diagram illustrating a functional configuration of an image defect inspection apparatus. As illustrated in FIG. 1, an image defect inspection apparatus 100 includes a master image input unit 101, a scanned image input unit 102, a detection process unit 103, a defect level determination unit 104, a detection-result alignment process unit 105, a detection result display unit 106, a feedback input unit 107, a detection level adjustment unit 108. The functional units are implemented by a central processing unit (CPU) that executes a control program stored in a memory.

The master image input unit 101 inputs original data for printing as a master image. The scanned image input unit 102 is an example of a scanned image input unit that inputs a scanned image acquired by reading an image with a reading device, printed by a print job of an image forming apparatus such as a printer. In one example, the reading device is a scanner that is communicable with the printer. In another example, the reading device is a scanner that is provided for the image forming apparatus, in a case where the image forming apparatus is a multifunctional printer having the printer and the scanner. The image forming apparatus, or the reading device, is communicably connected with the image defect inspection apparatus via any desired network.

The detection process unit 103 compares the master image with the scanned image to detect a defective portion (e.g., a dot or a streak) on the scanned image. The defect level determination unit 104 is an example of a defect level determination unit that digitizes a feature amount of a detected defective portion and assigns a level to the feature amount.

For example, the defect level determination unit 104 assigns a level to a defective portion according to the size of the defective portion as the feature amount. Accordingly, the level of a defective portion can be determined based on the size of the defective portion. Further, for example, the defect level determination unit 104 may assign a level to a defective portion using the luminance or the density of the defective portion as the feature amount.

Accordingly, the level of a defective portion can be determined based on the luminance or density of the defective portion. Further, for example, the defect level determination unit 104 assigns a level to a defective portion using the number of defective portions as the feature amount. Accordingly, the level of a defective portion can be determined based on the number of defects.

Further, for example, the defect level determination unit 104 may assign a level to a defective portion according to the type of the defective portion. Accordingly, for example, assigning a high level to a linear defective portion and a low level to a dot-like defective portion can meet the inspection request of the user. Further, for example, the defect level determination unit 104 may switch a method of assigning a level to a defective portion for each type of image data. Accordingly, for example, the level of a photograph portion is assigned to be higher and the level of a character portion is assigned to be lower, so that the inspection request of the user is satisfied.

The detection-result alignment process unit 105 sorts the detected defect pages detected in the print job based on the level of a defective portion included in each detected defect page. The detection result display unit 106 is an example of a detection result display unit having a function of displaying a list of detected defect pages in the order sorted by the detection-result alignment process unit 105. The detected defective portions are classified into levels by the feature amounts such as the sizes and the density differences of the detected defective portions, and the detected defect pages are displayed in descending order of the level in the display of the result of the print job. Thus, the user checks the presence or absence of a problem in order from the detected defect page having the highest level, and it is not necessary to check the detected defect pages after the detected defect page determined to have no problem. Accordingly, the efficiency of the inspection work of the detected defect pages is enhanced.

The feedback input unit 107 is an example of an input unit for inputting, as feedback, a result of visual determination by the user on the detected defect page. Accordingly, the result of the visual determination by the user can be recorded. The detection level adjustment unit 108 is an example of a detection level adjustment unit that automatically adjusts the detection level of the defective portion so that the defective portion of the detected defect page determined by the user to be non-problematic (i.e., acceptable) is not determined as a defective portion at the time of the next detection process for the defective portion.

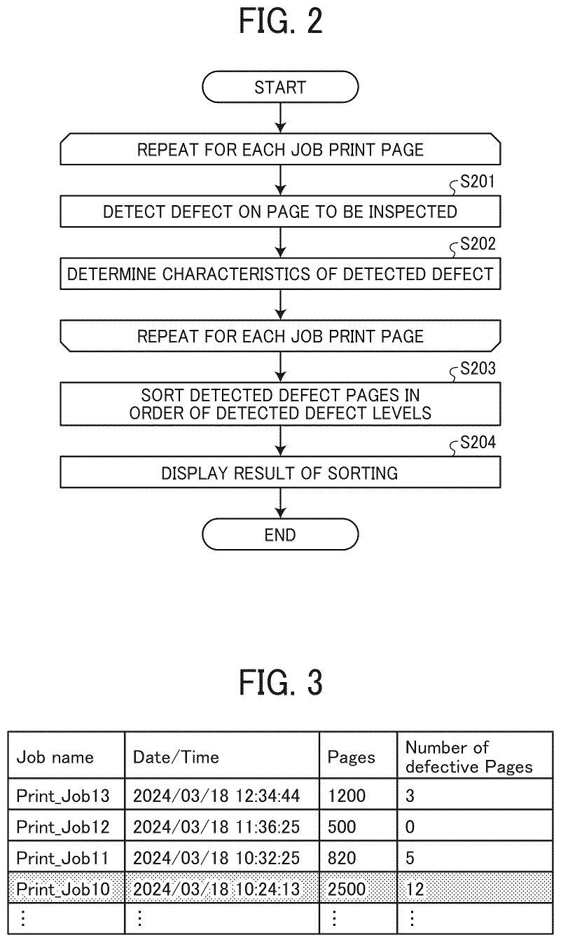

FIG. 2 is a flowchart of a process of displaying a list of detected defect pages in the image defect inspection apparatus 100. The image defect inspection apparatus 100 repeats the process illustrated in step S201 and step S202 for the number of pages of the print job.

The master image input unit 101 and the scanned image input unit 102 input a master image and a scanned image of a page to be inspected. In step S201, the detection process unit 103 compares the master image with the scanned image to detect a defective portion (e.g., a dot or a streak) on the scanned image. In step S202, the defect level determination unit 104 digitizes the feature amount (e.g., size and density) of the detected defective portion and assigns a level to the defective portion.

In step S203, the detection-result alignment process unit 105 sorts the detected defect pages detected in the print job in descending order from the defect-detected page having the highest level of the defect included in the defect-detected page. In step S204, the detection result display unit 106 displays a list of the detected defect pages in the sorted order. For example, any desired display, such as a liquid crystal display (LCD), is provided for the image defect inspection apparatus 100 to display a screen including the list of the detected defect pages.

FIG. 3 is a diagram illustrating a list of results of detected defect in print job in the image defect inspection apparatus 100. The detection result display unit 106 displays, e.g., the date and time (“Date/Time” as illustrated in FIG. 3) of printing, the number of pages (Pages), the number of defective pages (“Number of defective Pages” as illustrated in FIG. 3) in which a defective portion is detected for each print job (“Job name” as illustrated in FIG. 3). When the user selects a row of a print job whose details are to be checked, the detection result display unit 106 displays a screen indicating the details of the print job. The detection result display unit 106 may display a screen indicating a list of the detected defect results of the print jobs and a screen illustrating the details of the print jobs side by side on one screen. The detection result display unit 106 may perform screen transition from the screen illustrating the list of the detected defect results of the print jobs to the screen illustrating the details of the print jobs. The list of results of FIG. 3 may be stored in any desired memory provided for the image defect inspection apparatus 100.

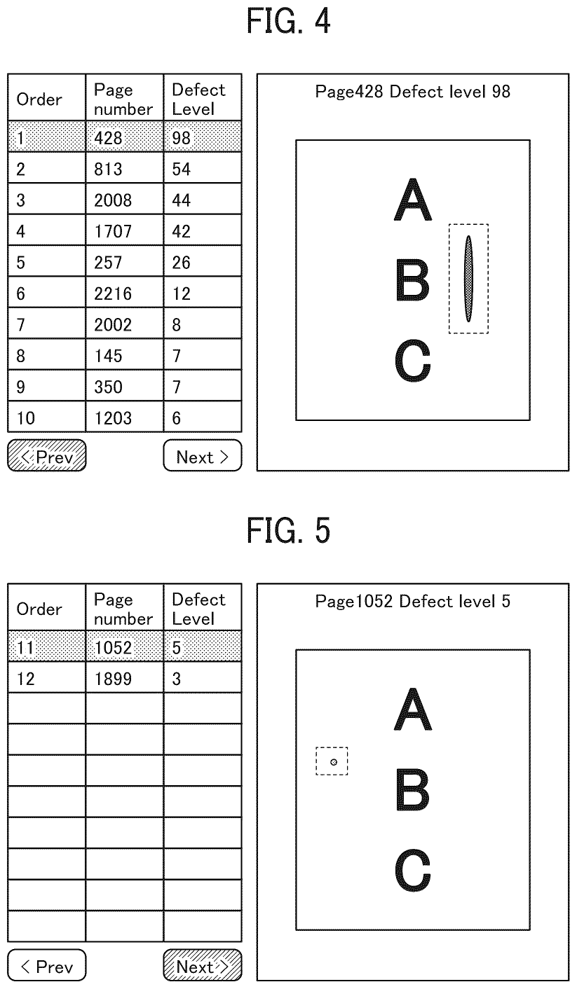

FIG. 4 and FIG. 5 are diagrams illustrating a list of results of detected defect in a print job in the image defect inspection apparatus 100. The detection result display unit 106 sorts and displays the detected defect pages in a print job in descending order (“Order”) of the defect level as illustrated in FIG. 4. In a case where the number of detected defect pages is too large to be contained in a table, the detection result display unit 106 may display a list of the remaining detected defect pages as illustrated in FIG. 5, for example, when the user clicks a “Next>” button below the table.

For example, when the user selects a row of a detected defect page to be checked, the detection result display unit 106 displays a screen so that the user can recognize which part of the print image is detected as a defective portion. Since the detection results are displayed in the list in descending order of the defect level, the user may check the printed result from the detected defect page with a low degree of defect.

As illustrated in FIG. 4, the user visually checks a printed matter from “Order: 1” in an order. For example, when it is determined that the defective portion of “Order: 5” with “Defect Level: 26” is a defect level with no problem, the subsequent visual inspection may be stopped, and the burden on the user is reduced. In FIGS. 4 and 5, an example of displaying defect levels by numerical values is illustrated, but the defect levels may be displayed by, e.g., symbols ranked like “A, B, and C.”

The defect level determination unit 104 may calculate the defect level of the defective portion based on, e.g., the size, density, or luminance of the defective portion. In addition, when the defect level determination unit 104 is to use a composite condition of the size and the density of the defective portion, the defect level determination unit 104 may calculate the defect levels of defective portions by performing weighted addition. For example, when a defective portion included in a photograph portion of a document is a problem, the defect level determination unit 104 may multiply a value of the detect level of the defective portion of the photograph portion by a weighting coefficient to adjust the value of the defect level of the defective portion.

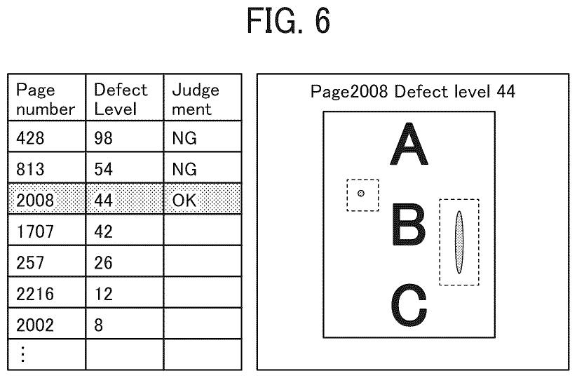

FIG. 6 is a diagram illustrating a list of results of detected defect in a print job in the image defect inspection apparatus 100. For example, on the display screen of the result of detected defect illustrated in FIG. 6, the user determines whether the actual printed matter has a problematic defect level in descending order of the defect level (“Defect Level”) of the defective portion, and inputs the determination result in the column of “Judgement.” The detection level adjustment unit 108 may adjust the threshold (level) for detecting a defective portion, re-execute the detection process for a defective portion of a detected defect page determined to be OK, search for a defect detection threshold (level) for determining that there is no defective portion, and apply the threshold (level) to the detection of a defective portion of the next print job when the search is successful.

The search for the threshold may be performed by, for example, a method of relaxing the threshold step by step. This reduces the number of reports of detected defect pages that do not cause a problem, and thus reduces the burden of visual inspection on the user.

As described above, according to the image defect inspection apparatus 100, detected defective portions are classified into levels by feature amounts such as the size and density difference thereof and the result of the print job is preferentially displayed from the detected defect page with a high level. Thus, the user checks the presence or absence of a problem in order from the detected defect page with a high level. It is not necessary to check the detected defect page after the detected defect page determined to be free from a problem, so that the efficiency of the inspection work of the detected defect page is improved.

The program executed by the image defect inspection apparatus 100 is provided by being incorporated in a read-only memory (ROM) or the like in advance. The program executed by the image defect inspection apparatus 100 may be stored in any computer-readable recording medium such as a compact disc-read-only memory (CD-ROM), a flexible disk (FD), a compact disc-recordable (CD-R), or a digital versatile disc (DVD) in a file format installable or executable by the computer, for distribution.

Furthermore, the program executed by the image defect inspection apparatus 100 may be stored in a computer connected to a network such as the Internet and provided by being downloaded via the network. The program executed by the image defect inspection apparatus 100 may be provided by being downloaded via a network. The program executed by the image defect inspection apparatus 100 may be provided or distributed via a network such as the Internet.

The program executed by the image defect inspection apparatus 100 has a module configuration including the above-described respective units (e.g., the master image input unit 101, the scanned image input unit 102, the detection process unit 103, the defect level determination unit 104, the detection-result alignment process unit 105, the detection result display unit 106, the feedback input unit 107, and the detection level adjustment unit 108). As actual hardware, a processor such as a central processing unit (CPU) reads the program from the ROM and executes the program, so that the respective units are loaded on a main storage device, and, e.g., the master image input unit 101, the scanned image input unit 102, the detection process unit 103, the defect level determination unit 104, the detection-result alignment process unit 105, the detection result display unit 106, the feedback input unit 107, and the detection level adjustment unit 108 are generated on the main storage device.

However, although the above-described image defect inspection apparatus has a function of displaying a list of defective pages detected in the print job, the user needs to check the presence or absence of a problem for all pages in which a defect is detected.

The present disclosure has been made in consideration of the above situation, and provides an image inspection apparatus, an image inspection method, and a non-transitory computer-readable medium that can enhance the efficiency of an inspection operation of a defect detection page.

According to the present disclosure, there is an effect that the efficiency of the inspection work of the defect detection page is enhanced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image inspection apparatus comprising circuitry configured to:
input a master image, the master image being original data for printing;
input a scanned image acquired by reading, with a reading device, an image printed by an image forming apparatus performing a print job;
compare the master image and the scanned image to detect a defective portion in the scanned image;
digitize a feature amount of the defective portion to assign a level to the defective portion based on the feature amount;
sort detected defect pages of the print job each page having the defective portion assigned with the level by the level of the defective portion in the detected defect page; and
display a list of the detected defect pages in an order having been sorted.

2. The image inspection apparatus according to claim 1, wherein the feature amount is a size of the defective portion.

3. The image inspection apparatus according to claim 1, wherein the feature amount is a luminance or a density of the defective portion.

4. The image inspection apparatus according to claim 1, wherein the feature amount is the number of defective portions.

5. The image inspection apparatus according to claim 1, wherein the circuitry is configured to:
assign the level to the defective portion further based on a type of the defective portion.

6. The image inspection apparatus according to claim 1, wherein the circuitry is further configured to:
switch a method of assigning the level to the defective portion according to a type of image data.

7. The image inspection apparatus according to claim 1, wherein the circuitry is further configured to:
input, as feedback, a result of visual determination by a user on the detected defect page.

8. The image inspection apparatus according to claim 1, wherein, in a case where the defective portion of the detected defect page is determined by a user as acceptable, the circuitry is further configured to:
automatically adjust a detection level of the defective portion so that the defective portion of the detected defect page is not determined as the defective portion in a next detection process.

9. An image inspection method performed by an image inspection apparatus, comprising:
inputting a master image, the master image being original data for printing;
inputting a scanned image acquired by reading an image with a reading device, the image printed by an image forming apparatus performing a print job;
comparing the master image and the scanned image to detect a defective portion in the scanned image;
digitizing a feature amount of the defective portion to assign a level to the defective portion based on the feature amount;
sorting detected defect pages of the print job each having the defective portion assigned with the level by the level of the defective portion in the detected defect page; and
displaying a list of the detected defect pages in an order sorted by the sorting.

10. A non-transitory recording medium storing a plurality of instructions which, when executed by one or more processors, causes the one or more processors to perform an image inspection method comprising:
inputting a master image, the master image being original data for printing;
inputting a scanned image acquired by reading an image with a reading device, the image printed by an image forming apparatus performing a print job;
comparing the master image and the scanned image to detect a defective portion in the scanned image;
digitizing a feature amount of the defective portion to assign a level to the defective portion based on the feature amount;
sorting detected defect pages of the print job each having the defective portion assigned with the level by the level of the defective portion in the detected defect page; and
displaying a list of the detected defect pages in an order sorted by the sorting.
